(19) United States
(12) Patent Application Publication
(10) Pub. No.: US 2007/0291216 A1
(43) Pub. Date: Dec. 20, 2007

(54) Liquid crystal display device with patterned black matrix for sealant

(75) Inventors: Chia-Ming Chan, Miao-Li (TW); Hung-Shien Cho, Miao-Li (TW); Kun-Hsing Hsiao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/820,103

(22) Filed: Jun. 18, 2007

(30) Foreign Application Priority Data
Jun. 16, 2006 (TW) 95121707

(51) Int. Cl. G02F 1/1333; G02F 1/1339

(52) U.S. Cl. 349/153; 349/110

(57) ABSTRACT

An exemplary liquid crystal display device includes a first substrate, a second substrate being disposed to spatially oppose to the first substrate and a sealant. The second substrate includes a base and a black matrix with a patterned structure. The sealant is formed between the first substrate and the patterned structure of the black matrix.

### FIELD OF THE INVENTION

The present invention relates to liquid crystal display (LCD) devices, and more particularly to a sealing structure for an LCD device.

### GENERAL BACKGROUND

Nowadays, more and more modern apparatuses, e.g. televisions, notebook computers, cell phones and personal digital assistants, include liquid crystal display devices. Liquid crystal display devices are popular because they can provide information and images with low power consumption. Further, a liquid crystal display device is thin and lightweight. Two important kinds of liquid crystal display device are the transmissive LCD device and the reflective LCD device. A transmissive LCD device typically includes at least one liquid crystal display panel together with a backlight. A reflective LCD device typically includes at least one liquid crystal display panel together with a reflecting element.

Referring to FIG. 16 and FIG. 17, a liquid crystal display device 10 includes a first substrate 110, a second substrate 120 being disposed to spatially oppose to the first substrate 110, a sealant 140, and a liquid crystal layer 130. The liquid crystal layer 130 is sealed within a cavity cooperatively formed by the sealant 140, the first substrate 110 and the second substrate 120.

The second substrate 120 includes a base 121 and a color filter layer 126. The color filter layer 126 includes a color layer 127 and a black matrix 125. The black matrix 125 includes a first black matrix portion 1250 and a second black matrix portion 1251. The color layer 127 includes red units 1271, green units 1273, and blue units 1275. The red units 1271, the green units 1273 and the blue units 1275 are disposed individually between the liquid crystal layer 130 and the base 121. The first black matrix portion 1250 is formed separately between the red units 1271, the green units 1273 and the blue units 1275 as viewed along a direction normal to the second substrate 120. The second black matrix portion 1251 is formed at a peripheral region of the base 121, as viewed along the direction normal to the second substrate 120.

The sealant 140 is formed between the first substrate 110 and the second black matrix portion 1251. Because the contact area as between the second black matrix portion 1251 and the sealant 140 is small, the adhesion between the second black matrix portion 1251 and the sealant 140 is weak. Therefore, the liquid crystal display device 10 is liable to become impaired or even destroyed. This is particularly the case when the liquid crystal display device 10 is subjected to shock or vibration, or when the liquid crystal display device 10 has aged somewhat.

It is desired to provide a liquid crystal display device with strong adhesion between a sealant and a substrate thereof.

### SUMMARY

A liquid crystal display device includes a first substrate, a second substrate being disposed to spatially oppose to the first substrate and a sealant. The second substrate includes a base and a black matrix with a patterned structure. The sealant is formed between the first substrate and the patterned structure of the black matrix.

A liquid crystal display device includes a first substrate, a second substrate being disposed to spatially oppose to the first substrate and a sealant. The second substrate includes a base, a black matrix with holes and protrusions formed in the holes. The sealant is formed between the first substrate and the patterned structure of the black matrix.

Because the whole area as between the patterned structure and the black matrix attaching to the sealant of the present invention is larger than that of black matrix attaches to the sealant of the conventional art. The adhesion between the patterned structure and the sealant of the present invention is larger than that of the conventional art. After the sealant is formed on the black matrix that is formed at a peripheral region of the base, the patterned structure provides the force parallel to the second substrate to keep the sealant on the same location of the surface of the second substrate because the protrusions are embedded within the sealant. Furthermore, the adhesion between the patterned structure and the sealant can also be increased by the material of the patterned structure and the sealant.

A detailed description of embodiments of the present invention is given below with reference to the accompanying drawings.

### BRIEF DESCRIPTION OF THE DRAWINGS

In the drawings, all the views are schematic.

FIG. 1 is a top plan, cutaway view of a liquid crystal display device in accordance with a first embodiment of the present invention.

FIG. 2 is an enlarged, cross-sectional view of part of the liquid crystal display device of FIG. 1, taken along line II-II thereof.

FIG. 3 is a cross-sectional view of part of a liquid crystal display device in accordance with a second embodiment of the present invention.

FIG. 4 is a cross-sectional view of part of a liquid crystal display device in accordance with a third embodiment of the present invention.

FIG. 5 is a cross-sectional view of part of a liquid crystal display device in accordance with a fourth embodiment of the present invention.

FIG. 6 is a cross-sectional view of part of a liquid crystal display device in accordance with a fifth embodiment of the present invention.

FIG. 7 is a cross-sectional view of part of a liquid crystal display device in accordance with a sixth embodiment of the present invention.

FIG. 8 is a cross-sectional view of part of a liquid crystal display device in accordance with a seventh embodiment of the present invention.

FIG. 9 is a cross-sectional view of part of a liquid crystal display device in accordance with an eighth embodiment of the present invention.

FIG. 10 is a top plan, cutaway view of a liquid crystal display device in accordance with a ninth embodiment of the present invention.

FIG. 11 is a top plan, cutaway view of a liquid crystal display device in accordance with a tenth embodiment of the present invention.

FIG. 11A is an enlarged view of a circled portion XIA of FIG. 11.

FIG. 12 is a top plan, cutaway view of a liquid crystal display device in accordance with an eleventh embodiment of the present invention.

FIG. 12A is an enlarged view of a circled portion XIIA of FIG. 12.

FIG. 13 is a top plan, cutaway view of a liquid crystal display device in accordance with a twelfth embodiment of the present invention.

FIG. 14 is an enlarged, cross-sectional view of part of the liquid crystal display device of FIG. 13, taken along line XIV-XIV thereof.

FIG. 15 is a top plan, cutaway view of a liquid crystal display device in accordance with a thirteenth embodiment of the present invention.

FIG. 16 is a top plan, cutaway view of a conventional liquid crystal display device.

FIG. 17 is an enlarged, cross-sectional view of part of the liquid crystal display device of FIG. 16, taken along line XVII-XVII thereof.

### DETAILED DESCRIPTION OF PREFERRED EMBODIMENTS

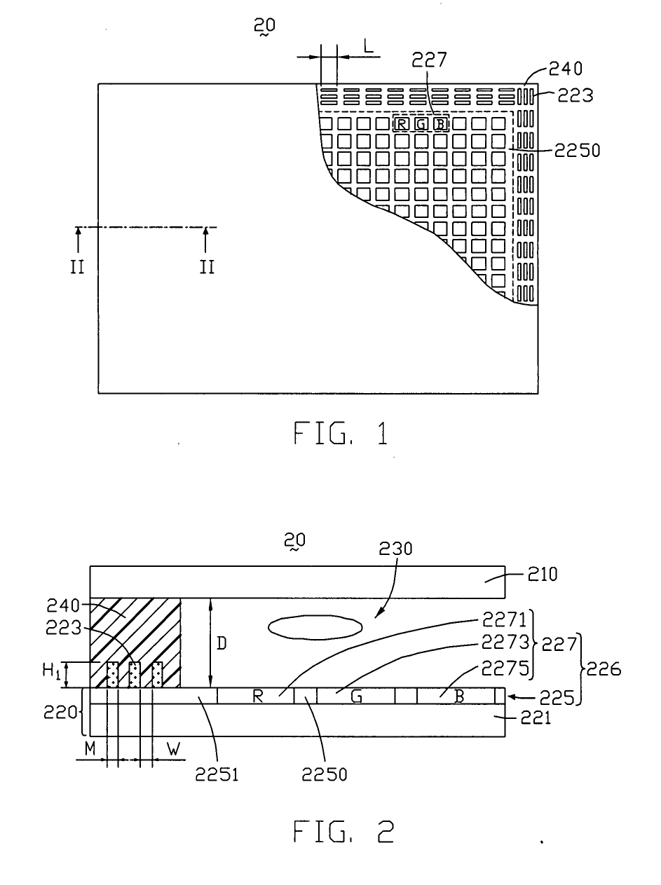

Referring to FIG. 1 and FIG. 2, a liquid crystal display device 20 of the first embodiment of the present embodiment includes a first substrate 210, a second substrate 220 being disposed to spatially oppose to the first substrate 210, a sealant 240 and a liquid crystal layer 230. The liquid crystal layer 230 is sealed within a cavity formed by the sealant 240, the first substrate 210 and the second substrate 220. Other elements that are not important for the features of the present embodiment are not depicted within the figures.

The second substrate 220 includes a base 221, a color filter layer 226 and a patterned structure. The patterned structure has a plurality of strip-shaped protrusions 223 arranged in rows and columns on a surface of the second black matrix 2251. The patterned structure of this embodiment has many protrusions 223 for embedded with the sealant 240. The color filter layer 226 includes a color layer 227 and a black matrix 225 including a first black matrix portion 2250 and a second black matrix portion 2251. The color layer 227 includes red units 2271, green units 2273 and blue units 2275. The red units 2271, the green units 2273 and the blue units 2275 are disposed individually between the liquid crystal layer 230 and the base 221. The first black matrix portion 2250 is formed separately between the red units 2271, the green units 2273 and the blue units 2275, as viewed along a direction normal to the second substrate 220. The second black matrix portion 2251 is formed at a peripheral region (outside the active/display area) of the base 221 as viewed along the direction normal to the second substrate 220.

The protrusions 223 are arranged as an array on the surface of the second black matrix portion 2251. Thus the patterned structure has an array of rectangular or oblong parts, as viewed along a direction normal to the second substrate 220.

The sealant 240 is formed between the first substrate 210 and the second black matrix portion 2251 and embedded in the intervals between two adjacent protrusions 223. In the preferred embodiment, the distance d between the edge of the base 221 and the external peripheral edge of the sealant 240 is designed in the region between 0 μm to 1500 μm, wherein as shown in FIG. 2, the distance d is 0 μm. The thickness D of the sealant 240 in this embodiment is 5.5 μm. The height H₁ of the protrusion 223 is designed in the region between 0.5 μm to 3.5 μm. The width M of the protrusion 223 is designed in the region between 5 μm to 500 μm. The distance W between two adjacent protrusions 223 is designed in the region between 5 μm to 500 μm.

In the preferred embodiment, the first black matrix portion 2250 and the second black matrix portion 2251 are made by chromium. The protrusion 223 can also be made by chromium. Otherwise, the protrusion 223 may be made by other material, e.g. Indium Tin Oxide, CrOx (x is at least in the range from 1 to 3), or CrNx (x is at least in the range from 1 to 3), etc. Moreover, if the second black matrix portion 2251 is made by the resin, the protrusion 223 can be made by the resin or something that can attach to the second black matrix portion 2251 well.

Because the whole area as between the protrusion 223 and the second black matrix portion 2251 attaching to the sealant 240 in the present embodiment is larger than that of the first black matrix portion 1251 attaching to the sealant 140. The adhesion between the protrusion 223 and the sealant 240 in the present embodiment is larger than that of the conventional art. The increased superficial measurement of the area between all protrusions 223 and the sealant 240 can be calculated by the following formula:
S=(2H₁M+2H₁L)n
wherein n is used as a symbol for the amount of the protrusions 223 and L is used as a symbol for the length of a protrusion 223.

Furthermore, after the sealant 240 is formed on the second black matrix portion 2251, the protrusions 223 provide the force parallel to the second substrate 220 to keep the sealant 240 on the same location of the surface of the second substrate 220 because the protrusions 223 are embedded within the sealant 240. Thus, the sealed condition within the first substrate 210, the second substrate 220 and the sealant 240 becomes better due to the protrusion 223 in the present embodiment.

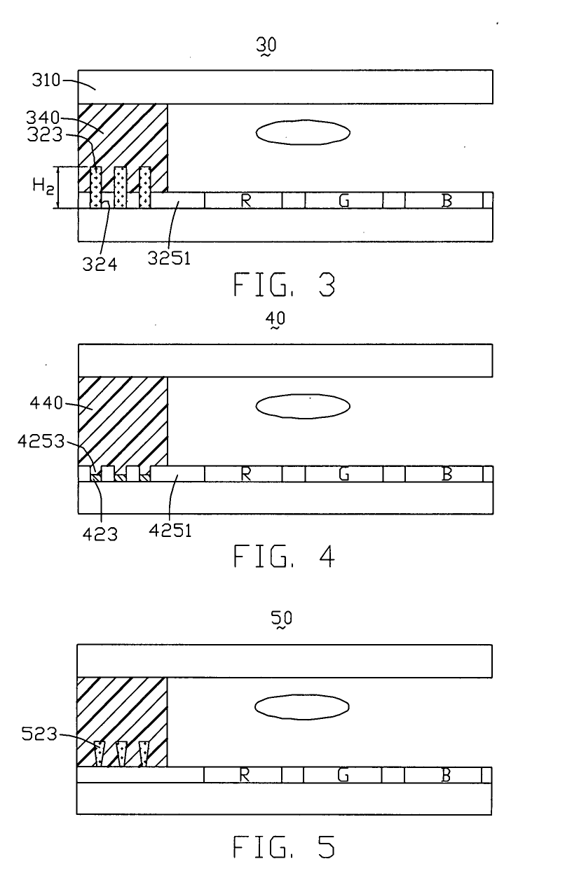

Referring to FIG. 3, the configuration of the liquid crystal display device 30 in the second embodiment is similar to that in the first embodiment. The structure of a third black matrix portion 3251 is different from the structure of the second black matrix portion 2251. The third black matrix portion 3251 includes a patterned structure including a plurality of holes 324. The holes 324 are arranged as an array arrangement. The plurality of protrusion 323 respectively fixed in a hole 324 and attached to a sealant 340 that is attached to a first substrate 310. The height of the protrusion 323 is higher than the depth of the hole 324. The height of the protrusion 323 is designed in the region between 3,5 μm to 6.5 μm.

Referring to FIG. 4, the configuration of the liquid crystal display device 40 in the third embodiment is similar to that in the second embodiment, except that a fourth black matrix portion 4251 including a patterned structure, having a plurality of holes 4253 arranged as an array arrangement, and a plurality of protrusions 423 respectively formed in the holes 4253. The height of the protrusion 423 is lower than the depth of the hole 4253. A portion of the sealant 440 is formed in the holes 4253.

Referring to FIG. 5, the configuration of the liquid crystal display device 50 in the fifth embodiment is similar to the liquid crystal display device 20 in the first embodiment, except that a patterned structure 523 has many inverted-trapezoidal protrusions that are formed separately as shown in FIG. 5. Of course the patterned structure 523 in different embodiments may have trapezoidal protrusions that are shaped differently from those shown in FIG. 5.

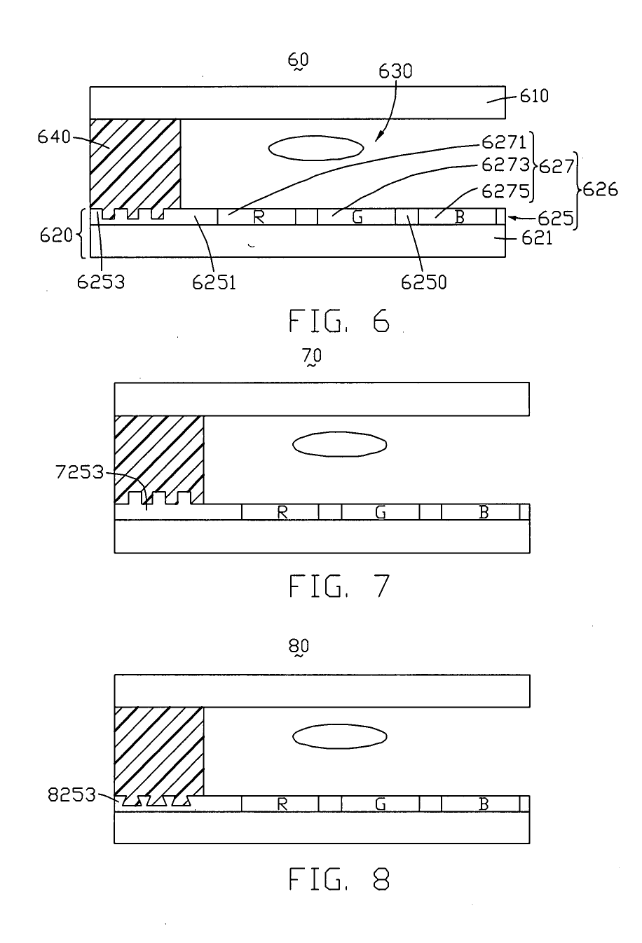

Referring to FIG. 6, a liquid crystal display device 60 in the fifth embodiment includes a first substrate 610, a second substrate 620 being disposed to spatially oppose to the first substrate 610, a sealant 640 and a liquid crystal layer 630. The liquid crystal layer 630 is sealed within a cavity formed by the sealant 640, the first substrate 610 and the second substrate 620.

The second substrate 620 includes a base 621 and a color filter layer 626. The color filter layer 626 includes a color layer 627 and a black matrix 625 that includes a first black matrix portion 6250 and a second black matrix portion 6251. The color layer 627 includes red units 6271, green units 6273 and blue units 6275. The red units 6271, the green units 6273 and the blue units 6275 are disposed individually between the liquid crystal layer 630 and the base 621. The first black matrix portion 6250 is formed separately between the red units 6271, the green units 6273 and the blue units 6275 as viewed along the direction normal to the second substrate 620. The second black matrix portion 6251 is formed at a peripheral region (outside the active/display area) of the base 621 as viewed along the direction normal to the second substrate 620. The second black matrix portion 6251 includes a patterned structure 6253 contacted with the sealant 640. The patterned structure 6253 in this embodiment has many oblong grooves that are formed separately as shown in FIG. 6. Partial sealant 640 is formed inside an oblong groove of the patterned structure 6253. Of course the patterned structure 6253 in different embodiment may has only an oblong groove that is different from that as shown in FIG. 6.

Because the whole area as between the patterned structure 6253 and the second black matrix portion 6251 attaching to the sealant 640 in the this embodiment is larger than that of second black matrix portion 1251 attaching to the sealant 140 of the conventional art. The adhesion between the patterned structure 6253 and the sealant 640 in the present embodiment is larger than that of the conventional art. Furthermore, because partial sealant 640 is formed inside the patterned structure 6253, the patterned structure 6253 provides the force parallel to the second substrate 620 to keep the sealant 640 on the same location of the surface of the second substrate 620 thus. Thus the sealed condition within the first substrate 210, the second substrate 220 and the sealant 240 becomes better due to the protrusion 223.

Referring to FIG. 7, the configuration of the liquid crystal display device 70 in the sixth embodiment is similar to the liquid crystal display device 60 in the fifth embodiment. A patterned structure 7253 has many trapezoidal protrusions that are raised on the surface of the second substrate.

Referring to FIG. 8, the configuration of the liquid crystal display device 80 in the seventh embodiment is similar to the liquid crystal display device 60 in the fifth embodiment. A patterned structure 8253 has many inverted-trapezoidal grooves depicted in FIG. 8.

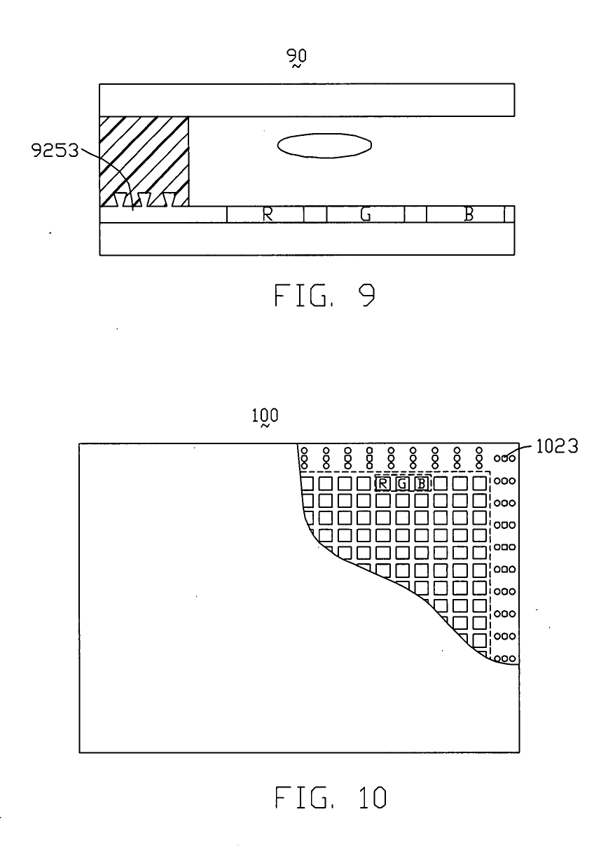

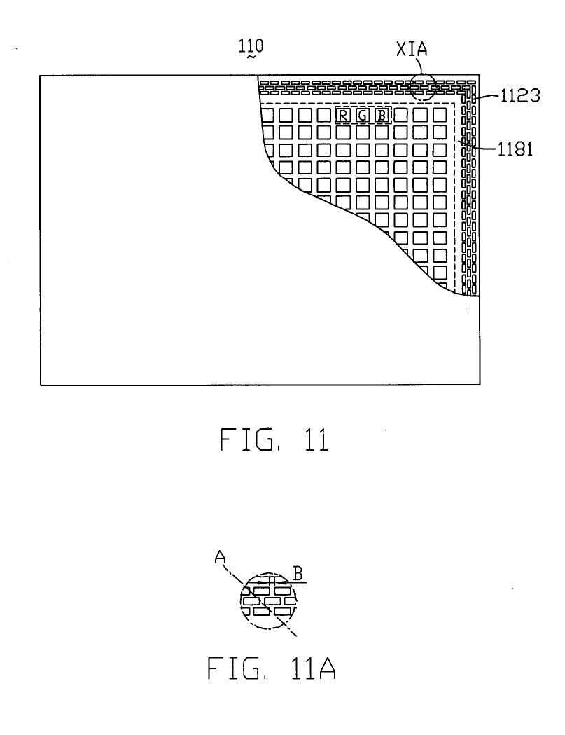

Referring to FIG. 9, the configuration of the liquid crystal display device 90 in the eighth embodiment is similar to the liquid crystal display device 70 in the sixth embodiment. A patterned structure 9253 has many inverted-trapezoidal protrusions that are raised on the surface of the second substrate.

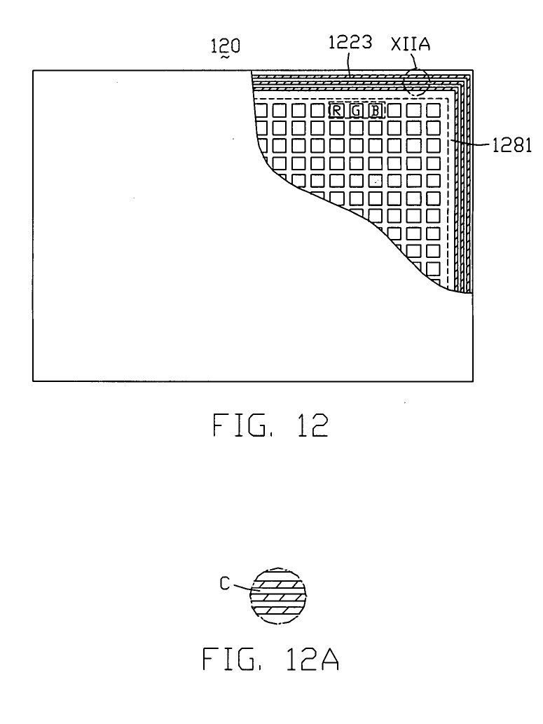

Referring to FIG. 10, the configuration of the liquid crystal display device 100 in the ninth embodiment is similar to the liquid crystal display device 10 in the first embodiment. A patterned structure 1023 is an array arrangement of circles as viewed along the direction normal to the second substrate.

Referring to FIG. 11, the configuration of the liquid crystal display device 110 in the tenth embodiment is similar to the liquid crystal display device 10 in the first embodiment. A patterned structure 1123 includes rows of protrusions along an edge of the black matrix 1181 of the second substrate as shown in FIG. 11. The structure within the circled portion XIA is shown in FIG. 11A in detail. The different rows of protrusions are parallel to each other. The direction A that passes two edges of two closest protrusions of two different rows is not perpendicular to the direction of the rows of protrusions. Furthermore, there is an interval B between two protrusions of the same row.

Referring to FIG. 12, the configuration of the liquid crystal display device 120 in the eleventh embodiment is similar to the liquid crystal display device 10 in the first embodiment. A patterned structure 1223 includes rows of protrusions along an edge of the black matrix 1281 as shown in FIG. 12. The structure within the circled portion XIIA is shown in FIG. 12A in detail. The different rows of protrusions are parallel to each other. A row is formed beside another row with an interval C. Furthermore, there is no interval between two protrusions of the same row.

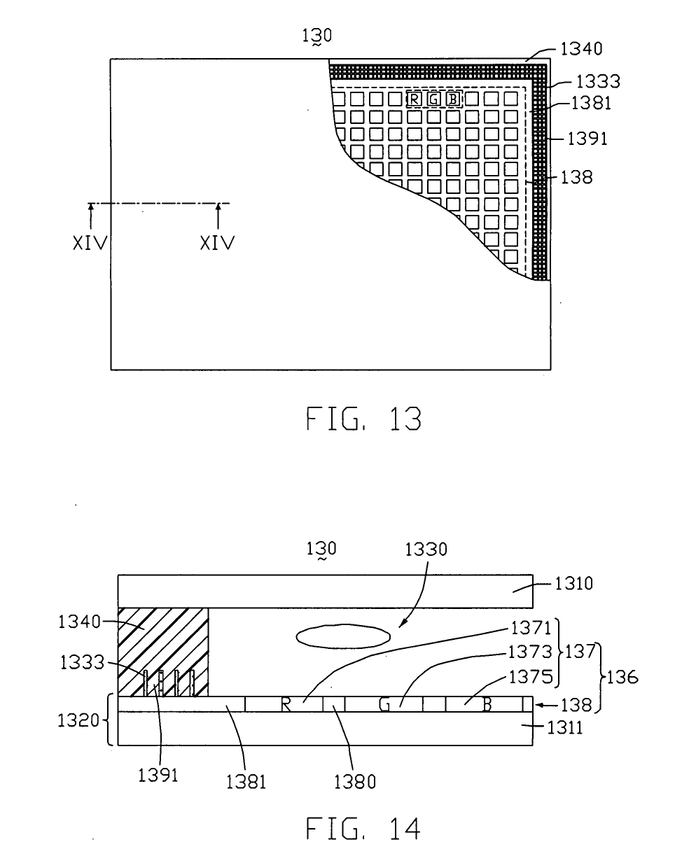

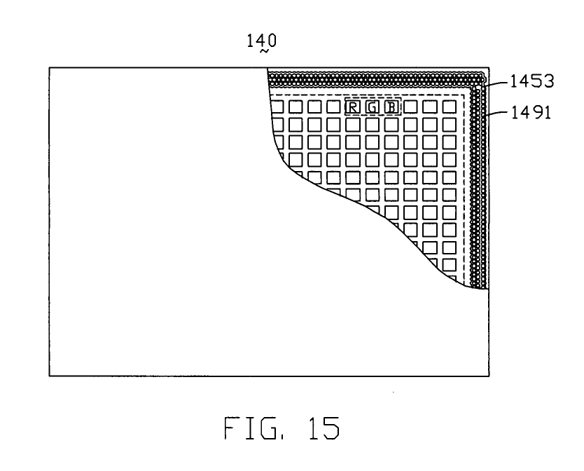

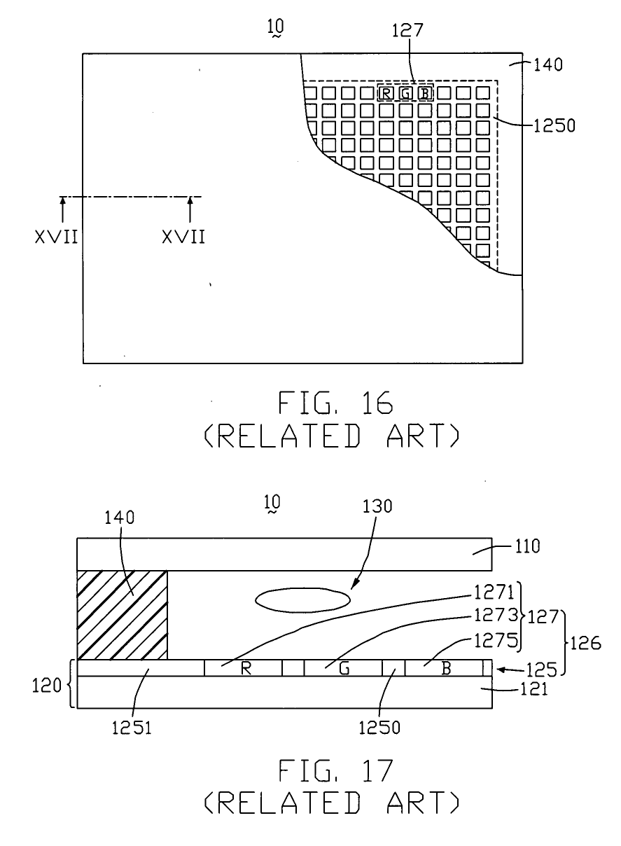

Referring to FIG. 13 and FIG. 14, a liquid crystal display device 130 in the twelfth embodiment includes a first substrate 1310, a second substrate 1320 being disposed to spatially oppose to the first substrate 1310, a sealant 1340 and a liquid crystal layer 1330. The liquid crystal layer 1330 is sealed within a cavity formed by the sealant 1340, the first substrate 13 10 and the second substrate 1320.

The second substrate 1320 includes a base 1311, a color filter layer 136 and a patterned structure such as a protrusion 1333. The color filter layer 136 includes a color layer 137 and a black matrix 138 that includes a first black matrix portion 1380 and a second black matrix portion 1381. The color layer 137 includes red units 1371, green units 1373 and blue units 1375. The red units 1371, the green units 1373 and the blue units 1375 are disposed individually between the liquid crystal layer 1330 and the base 1311. The first black matrix portion 1380 is formed separately between the red units 1371, the green units 1373 and the blue units 1375 as viewed along the direction normal to the second substrate 1320. The second black matrix portion 1381 is formed at a peripheral region (outside the active/display area) of the base 1311 as viewed along the direction normal to the second substrate 1320. The protrusion 1333 is formed on the second black matrix portion 1381 and embeds with the sealant 1340. The protrusion 1333 in this embodiment includes a plurality of holes 1391 which are depicted in FIG. 13 and FIG. 14. The hole 1391 is an oblong hole. The sealant 1340 is formed between the first substrate 1310 and the second black matrix portion 1381 as depicted in FIG. 16.

Referring to FIG. 15, the configuration of the liquid crystal display device 140 in the thirteenth embodiment is similar to the liquid crystal display device 130 in the twelfth embodiment. The protrusion 1453 includes a plurality of holes 1491 as shown in FIG. 15. The hole 1491 is a hexagonal hole.

The configuration of the liquid crystal display device in the fourteenth embodiment is similar to the liquid crystal display device 60 in the fifth embodiment. The patterned structure has an array arrangement of circles as viewed along the direction normal to the second substrate.

The configuration of the liquid crystal display device in the fifteenth embodiment is similar to the liquid crystal display device 60 in the fifth embodiment. A patterned structure includes rows of trapezoids. The different rows of trapezoids are parallel to each other. The direction passes two edges of two closest trapezoids of two different rows is not perpendicular to the direction of the rows of trapezoids. Furthermore, there is an interval between two trapezoids of the same row.

The liquid crystal display device in the present embodiment can be changed, e.g. the patterned structure in the fifth embodiment and the sixth embodiment may be changed to another shape other than an oblong or a trapezoid if it is necessary.

While preferred and exemplary embodiments have been described above, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A liquid crystal display device, comprising:
a first substrate;
a second substrate disposed to spatially oppose to the first substrate, wherein the second substrate includes a base and a black matrix being formed on the base; and
a sealant formed between the first substrate and the black matrix;
wherein the black matrix includes a patterned structure embedded with the sealant.

2. The liquid crystal display device as claimed in claim 1, wherein the patterned structure has a plurality of oblong grooves arranged in matrix.

3. The liquid crystal display device as claimed in claim 1, wherein the patterned structure has an inverted-trapezoidal groove.

4. The liquid crystal display device as claimed in claim 1, wherein the patterned structure has an oblong protrusion.

5. The liquid crystal display device as claimed in claim 1, wherein the patterned structure has an inverted-trapezoidal protrusion.

6. The liquid crystal display device as claimed in claim 1, wherein the patterned structure has an array arrangement of oblongs as viewed along a direction normal to the second substrate.

7. The liquid crystal display device as claimed in claim 1, wherein the patterned structure has an array arrangement of circles as viewed along a direction normal to the second substrate.

8. The liquid crystal display device as claimed in claim 1, wherein the patterned structure includes a plurality of rows of protrusions along an edge of the second substrate.

9. The liquid crystal display device as claimed in claim 8, wherein there is an interval between two protrusions of a row.

10. The liquid crystal display device as claimed in claim 8, wherein a direction that passes two edges of two closest protrusions of two different rows is not perpendicular to the direction of the rows of protrusions.

11. The liquid crystal display device as claimed in claim 8, wherein a row is formed beside another row with an interval.

12. A liquid crystal display device, comprising:
a first substrate;
a second substrate disposed to spatially oppose to the first substrate, wherein the second substrate includes a base, a black matrix being formed at a peripheral region of the base and a plurality of protrusions being formed above a surface of the black matrix; and
a sealant formed between the first substrate and the black matrix, wherein the protrusion is embedded between the sealant and the black matrix.

13. The liquid crystal display device as claimed in claim 12, wherein the protrusion includes a plurality of oblong holes.

14. The liquid crystal display device as claimed in claim 12, wherein the protrusion includes a plurality of hexagonal holes.

15. The liquid crystal display device as claimed in claim 12, wherein the black matrix is made by chromium and the protrusion is made by one kind of material selected from the group consisting of chromium, Indium Tin Oxide, CrOx, CrNx.

16. The liquid crystal display device as claimed in claim 12, wherein the black matrix comprises resin, and the protrusion comprises resin.

17. A liquid crystal display device, comprising:
a first substrate;
a second substrate disposed to spatially oppose to the first substrate, wherein the second substrate includes a base, a black matrix being set on the base, a plurality of hole formed in the black matrix and at least one protrusion formed in the hole; and
a sealant formed between the first substrate and the black matrix, wherein the hole and the protrusion are embedded between the sealant and the black matrix.
